(19) United States
(12) Patent Application Publication
(10) Pub. No.: US 2023/0408706 A1
(43) Pub. Date: Dec. 21, 2023

(54) METHOD FOR POSITIONING IN A NON-TERRESTRIAL COMMUNICATIONS NETWORK

(71) Applicant: Sony Group Corporation, Tokyo (JP)

(72) Inventors: Fredrik RUSEK, Eslöv (SE); Erik Lennart BENGTSSON, Eslöv (SE); Basuki PRIYANTO, Lund (SE); Anders BERGGREN, Lund (SE); Zhinong YING, Lund (SE)

(21) Appl. No.: 18/035,085

(22) PCT Filed: Oct. 20, 2021
(86) PCT No.: PCT/EP2021/079061

§ 371 Date: May 2, 2023

(30) Foreign Application Priority Data
Nov. 20, 2020 (SE) 2051361-0

(51) Int. Cl. G01S 19/38

(52) U.S. Cl. CPC G01S 19/38

(57) ABSTRACT

A method carried out in a user equipment, UE, for facilitating positioning of the UE in a communication network comprising a non-terrestrial access network of satellite-based access nodes, the method comprising: receiving at least two references signals which are transmitted at different occasions from the same satellite-based access node at different satellite trajectory positions; obtaining, for each received reference signal, a time stamp of reception and a reference signal occasion identifier conveyed in the reference signal, for calculation of a UE position.

### TECHNICAL FIELD

This disclosure relates to solutions for positioning of a wireless device in a non-terrestrial communications network. Specifically, solutions are provided for receiving references signals transmitted at different occasions from the same satellite-based access node at different positions along a satellite trajectory, wherein a position of the wireless device may be determined based on measurements on the received signals.

### BACKGROUND

In a cellular radio communications system, wireless devices may act as mobile terminals for operation by radio communication with base stations, or access nodes, of a wireless communications network. It may be noted that the most common term for wireless devices configured to operate by wireless communication is User Equipment (UE), a term which will also be used herein going forward. The cellular communications networks may e.g. be configured and operated under the specifications provided under the 3rd Generation Partnership Project (3GPP).

Positioning of a UE relates to the process of calculating an estimate of the location of the UE, either geographically or with reference to some other reference system. The purpose may e.g. be for the network or other system to provide position-dependent services, such as tracking or tailoring of services or offers. The initiator, i.e. the entity requesting the position, may be the UE itself, or its user, or another entity.

Off-shore and rural area positioning of today is mainly obtained from global navigation satellite systems (GNSS), such as e.g. GPS, GLONASS, BeiDou etc. Such positioning techniques require both a dedicated receiver and antenna in the UE. Furthermore, positioning techniques have been developed and incorporated in 3GPP systems, based on estimated time of arrival or positioning reference signals, and trilateration/multilateration based on obtained such measurements. OTDOA (Observed Time Difference Of Arrival) is an example of such a positioning feature introduced in E-UTRA (LTE radio). The UE measures the time difference between some specific signals from several access nodes and reports these time differences to a positioning node in the wireless network, referred to as the ESMLC (Evolved Serving Mobile Location Center).

Further releases of the 3GPP system specifications will provide improvements in the field of Non-Terrestrial Networks (NTN), which means access networks including satellite-based access nodes, or TRPs (Transmission and Reception Points). NTN has the target to offer connectivity with global coverage. In 3GPP rel. 17, NTN is assumed to utilize the existing GNSS. In the future, we expect NTN to have its own positioning techniques integrated in the 3GPP NTN system. This will make a smooth operation of the NTN system that may require positioning services. Furthermore, a separate antenna/receiver for the existing GNSS is no longer required in the UE. This would reduce UE complexity/cost. Positioning in NTN is essential with the main purpose to support NTN communication systems and also to locate the UE attached to the NTN system, especially when the terrestrial 3GPP access network is not available, such as offshore or in rural areas.

Positioning in terrestrial 5G systems, using multiple access node (gNB) antennas, and applying beam forming, has already been considered. The approach is to beamform each positioning reference signal (PRS) and include directive properties. However, one challenge in NTN is that the large distance between a UE and a single gNB does not offer a good position accuracy, since a single beam will cover a large area. To achieve improved accuracy a UE needs to see multiple gNBs and perform so called multi-lateration. This method may be challenging in NTN as the satellites are moving and also not expected to have large overlap in coverage of terrestrial areas. Positioning in NTN must therefore be obtained in a different way than legacy multi-lateration methods used in terrestrial networks.

### SUMMARY

There is consequently a need for improvement of the field of UE positioning in wireless communications networks, where an NTN access network is employed. The proposed methods associated with such improvement are outlined in the independent claims. Further advantageous features are set out in the dependent claims.

According to one aspect, a method carried out in a UE is provided for facilitating positioning of the UE in a communication network comprising a non-terrestrial access network of satellite-based access nodes, the method comprising:
receiving at least two references signals which are transmitted at different occasions from the same satellite-based access node at different satellite trajectory positions;
obtaining, for each received reference signal, a time stamp of reception and a reference signal occasion identifier conveyed in the reference signal, for calculation of a UE position.

Based on the time stamp of reception and the associated reference signal occasion identifier within a single positioning occasion, an estimation of the UE position may be determined, either in a positioning node in the network or by the UE.

### BRIEF DESCRIPTION OF THE DRAWINGS

Various examples and use cases of the proposed solution will be described below with reference to the accompanying drawings, in which

FIG. 1 illustrates a wireless network including a non-terrestrial access network, in which network the proposed solutions may be carried out;

FIG. 2A schematically illustrates working principles of terrestrial positioning;

FIGS. 2B and 2C schematically illustrate working principles of non-terrestrial positioning;

FIG. 3 schematically illustrates functional elements of a UE configured to carry out various aspects of the proposed solution;

FIG. 4 schematically illustrates functional elements of an NTN access node configured to carry out various aspects of the proposed solution;

FIG. 5 schematically illustrates functional elements of a positioning node configured to carry out various aspects of the proposed solution;

FIG. 6 schematically illustrates configuration of reference signal transmitted from NTN access nodes for positioning purposes in various aspects of the proposed solution;

FIG. 7A schematically illustrates an NTN system in which the proposed methods may be carried out, wherein a coverage of an NTN access node is locked to a certain region as the satellite carrying the NTN access node passes along a trajectory;

FIG. 7B schematically illustrates an NTN system in which the proposed methods may be carried out, wherein a coverage of an NTN access node is swept over land as the satellite carrying the NTN access node passes along a trajectory;

FIG. 8 schematically illustrates coverage areas of different NTN access nodes in the vicinity of a UE;

FIG. 9 schematically illustrates coverage area of one beam dependent on region for an NTN access node.

### DETAILED DESCRIPTION

In the following description, for purposes of explanation and not limitation, details are set forth herein related to various examples. However, it will be apparent to those skilled in the art that the present invention may be practiced in other examples that depart from these specific details. In some instances, detailed descriptions of well-known devices, circuits, and methods are omitted so as not to obscure the description of the present invention with unnecessary detail. The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented and are thus machine-implemented. In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) (ASIC), and (where appropriate) state machines capable of performing such functions. In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

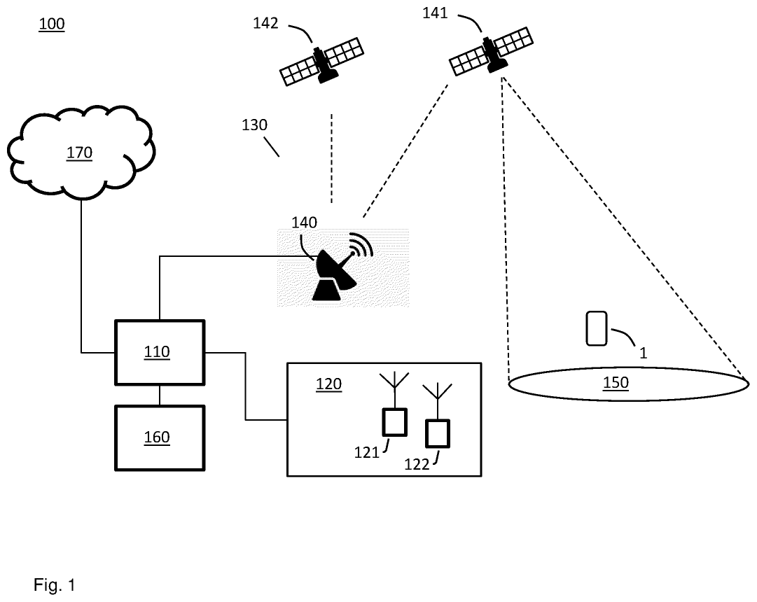

FIG. 1 schematically illustrates a wireless communication system, providing an example of a scene in which the solutions provided herein may be incorporated. The wireless communication system includes a wireless network 100, and a UE (or wireless device) 1 configured to wirelessly communicate with the wireless network 100. The wireless network 100 comprises a core network 110, which is connected to other communication networks 170. The wireless network 100 further comprises one or more access networks 120, 130, usable for communication with UEs of the system. Such access networks may comprise a terrestrial network 120 comprising a plurality of access nodes or base stations 121, 122, configured to provide a wireless interface for, inter alia, the UE 1. The base stations 121, 122 may be stationary or mobile. Each base station, such as the terrestrial base station 121, 122, comprises a point of transmission and reception, referred to as a Transmission and Reception Point (TRP), which coincides with an antenna of the respective base station. Logic for operating the base station may be configured at the TRP or at another physical location. The access network may further comprise a non-terrestrial network 130. The non-terrestrial network 130 may comprise one or more satellites 141, 142, configured to transmit signals associated with a cell of the wireless network 100 within a coverage area 150. A ground station 140 of the non-terrestrial network 130 may be connected to the core network 110, and wirelessly connected to one or more of the satellites 141, 142. Each satellite 141, 142 may be seen as one NTN TRP for the respective NTN base station or access node, realizing an NTN cell, whereas logic and hardware for each such non-terrestrial network base station may be completely or partly configured in the ground station 140 or in other nodes of the access network 130. A positioning node 160 may be connected to the core network 110 and be configured to calculate a UE position based on received measurement data.

The UE 1 may be any device operable to wirelessly communicate with the network 100 through the base stations 121, 122 and/or the NTN TRPs 141, 142, such as a mobile telephone, computer, tablet, a M2M device or other. The UE 1 can be configured to communicate in more than one beam, which are preferably orthogonal in terms of coding and/or frequency division and/or time division. Configuration of beams in the UE 1 may be achieved by a spatial filter realized by using an antenna array configured to provide an anisotropic sensitivity profile to transmit radio signals in a particular transmit direction.

The solutions proposed herein include methods for facilitating positioning of the UE 1 in a communication network 100 comprising a non-terrestrial access network 130 based on signals transmitted from at least one moving satellite-based TRP 141 with a known trajectory. One aspect of the idea is based on the notion that the satellite-based TRP 141 which is transmitting reference signals is moving, whereby there is an association of the timing of reference signal transmission occasions and satellite location. This can facilitate the UE positioning by a single moving satellite.

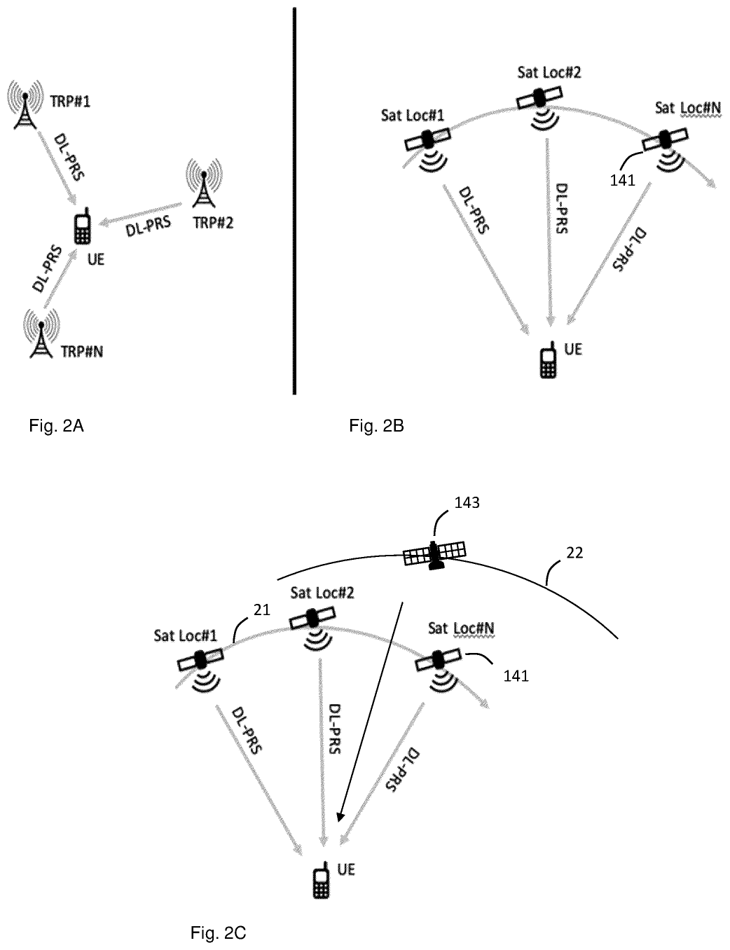

FIG. 2A schematically illustrates typical downlink (DL) positioning in a terrestrial network. Three TRPs are shown to facilitate multi-lateration for UE positioning estimation. The UE performs DL-TDoA (Time Difference of Arrival) measurements of Positioning Reference Signals (PRS) transmitted from the TRPs and reports the DL-TDoA measurement in the form of an RSTD report to a positioning node such as a Location Server (LS) 160. Based on these measurement results and known positions of TRPs, the positioning node 160 can perform UE positioning to obtain an estimated UE position.

FIG. 2B schematically illustrates a scenario in which the proposed solutions are based. Herein, the TRP 141 is satellite-based, i.e. an NTN TRP 141. As one satellite is moving, multiple virtual satellites/TRPs are created at different points in time. In this figure, the NTN TRP 141 transmits reference signals, such as DL-PRS, from three different positions. The UE can perform similar DL-TDoA measurements, within one positioning period or positioning occasion, and report to the LS 160. A mapping of PRS transmissions and the satellite location/trajectory is provided to the LS 160.

Measurements based on reference signals received from a single NTN TRP 141 at different positions along its trajectory may provide basis for calculating a position identified by a perpendicular distance from the projection of the trajectory on Earth. In various examples, further positioning information is obtained to distinguish at which side of that projection the UE 1 is determined to be located. In some examples, the further positioning information is a more coarse type of data, such as a last obtained terrestrial TRP ID, or beam ID, or even an obtained country code. In other examples, the further positioning information is obtained based on sensors, such as an Inertial Measurement Unit (IMU) in the UE 1, comprising e.g. one or more of an accelerometer, a gyroscope, and a magnetometer. The IMU may be configured to determine relative movement from a first point, such as a location where a last position estimation was obtained, to a second point, such as the location at which the measurement of received reference signals from the NTN TRP 141 is carried out. In order to distinguish between two calculated positions on either side of the projection of the satellite trajectory on Earth, the further positioning information can typically have comparatively low accuracy, comparative to the actual distance to the projection of the trajectory on Earth, which may be tens or hundreds of meters.

FIG. 2C schematically illustrates a scenario partly corresponding to FIG. 2B. In addition to the first NTN TRP 141, a second NTN TRP 143 is shown. As the NTN TRP 141 is moving, multiple virtual NTN TRPs are created and reference signals are transmitted from different positions along the trajectory 21. In this figure, the satellite transmits DL-PRS from two or more positions. Moreover, one or more additional reference signals transmitted from the second NTN TRP 143, which moves along a different trajectory 22, are received. In an alternative example, one or more additional reference signals transmitted from a single terrestrial TRP 121 are received. A time stamp associated with reception of such additional reference signal(s) is obtained in the UE 1, together with an identification of the received additional signal which identifies when that additional signal was transmitted. The result of that measurement of signals from the second NTN TRP 143, or terrestrial TRP 121, provides another example of said further positioning information, usable inter alia for distinguishing between two determined positions based on reference signals received from one and the same NTN TRP 141. Alternatively, tri-lateration (or multi-lateration) is carried out based on time stamps of reception of the reference signals from both the first NTN TRP 141 and from the second NTN TRP 143, or terrestrial TRP 121. Measurements may be carried out in the LS 160, upon receiving measurement data from the UE 1, or in the UE 1 by itself, based on obtained trajectory information. Further details regarding reference signal transmission and measurements on received reference signals will be described below.

Before discussing various process solutions for the proposed method, functional elements for at least some of the nodes involved will be briefly discussed.

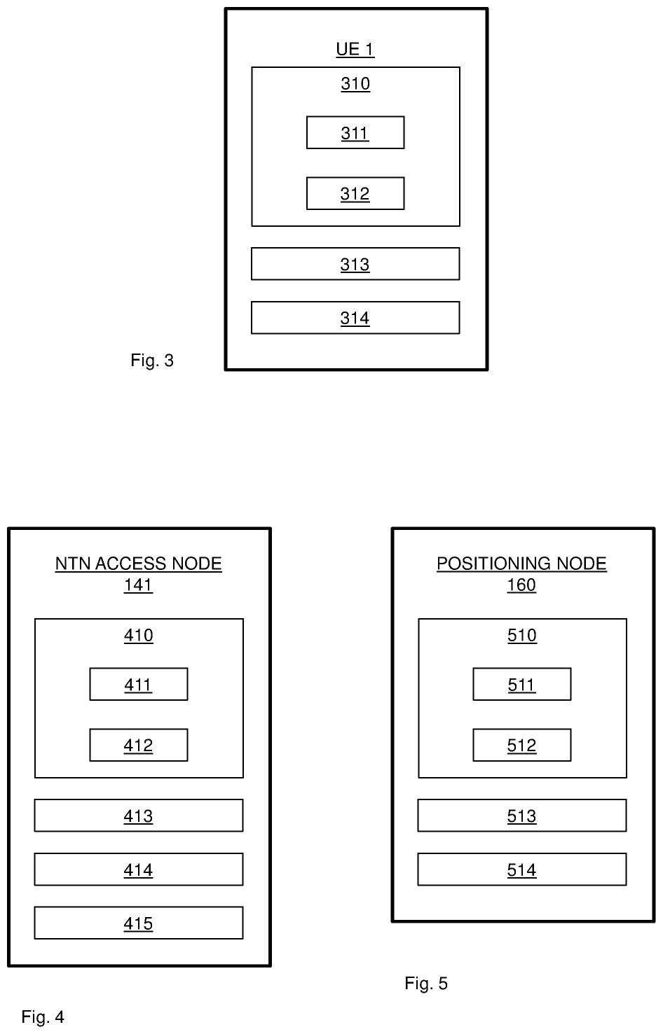

FIG. 3 schematically illustrates an example of the UE 1 for use in a wireless network 100 as presented herein, and for carrying out various method steps as outlined.

The UE 1 comprises a radio transceiver 313 for communicating with other entities of the radio communication network 100, such as the base station TRPs 121, 122, 141, 142, in different frequency bands. The transceiver 313 may thus include a radio receiver and transmitter for communicating through at least an air interface.

The UE 1 may further comprise an antenna system 314, which may include one or more antenna arrays. In various examples the UE 1 is configured to operate with a single beam, wherein the antenna system 314 is configured to provide an isotropic sensitivity to transmit radio signals. In other examples, the antenna system 314 may comprise a plurality of antennas for operation of different beams in transmission and/or reception.

The UE 1 further comprises logic circuitry 310 configured to communicate data, via the radio transceiver, on a radio channel, to the wireless communication network 100 and possibly directly with another terminal by Device-to Device (D2D) communication.

The logic circuitry 310 may include a processing device 311, including one or multiple processors, microprocessors, data processors, co-processors, and/or some other type of component that interprets and/or executes instructions and/or data. The processing device 311 may be implemented as hardware (e.g., a microprocessor, etc.) or a combination of hardware and software (e.g., a system-on-chip (SoC), an application-specific integrated circuit (ASIC), etc.). The processing device 311 may be configured to perform one or multiple operations based on an operating system and/or various applications or programs.

The logic circuitry 310 may further include memory storage 312, which may include one or multiple memories and/or one or multiple other types of storage mediums. For example, the memory storage 312 may include a random access memory (RAM), a dynamic random access memory (DRAM), a cache, a read only memory (ROM), a programmable read only memory (PROM), flash memory, and/or some other type of memory. The memory storage 312 may include a hard disk (e.g., a magnetic disk, an optical disk, a magneto-optic disk, a solid state disk, etc.). The memory storage 312 is configured for holding computer program code, which may be executed by the processing device 311, wherein the logic circuitry 310 is configured to control the UE 1 to carry out any of the method steps as provided herein. Software defined by said computer program code may include an application or a program that provides a function and/or a process. The software may include device firmware, an operating system (OS), or a variety of applications that may execute in the logic circuitry 310.

Obviously, the UE 1 may include other features and elements than those shown in the drawing or described herein, such as a power supply, a casing, a user interface, sensors, etc., but are left out for the sake of simplicity.

FIG. 4 schematically illustrates an example of an NTN access node 141 for use in a wireless network 100 as presented herein, and for carrying out various method steps as outlined. The function and configuration of the NTN access node 141 may apply also the other NTN access nodes mentioned herein. As indicated above, the NTN access node 141 is alternatively referred to herein as the NTN TRP 141. In the context of the present disclosure, an antenna system of the access node at least partly defines the NTN TRP, whereas others of the functional elements of the NTN access node described below may be situated remotely.

The NTN TRP 141 comprises a radio transceiver 413 for communicating with UEs of the radio communication network 100, such as the UE 1, in different frequency bands. The transceiver 413 may thus include a radio receiver and transmitter for communicating through at least an air interface.

The NTN access node 141 may further comprise, or be connected to, an antenna system 414, which may include one or more antenna arrays. The antenna system 414 may comprise a plurality of antennas for operation of different beams in transmission and/or reception.

The NTN access node 141 further comprises a core network interface 415 for communicating with various entities of the wireless network 100, such as the positioning node 160.

The NTN TRP 141 further comprises logic circuitry 410 configured to communicate data on a radio channel via the radio transceiver 413 to UEs, and configured to communicate data with the core network 110.

The logic circuitry 410 may include a processing device 411, including one or multiple processors, microprocessors, data processors, co-processors, and/or some other type of component that interprets and/or executes instructions and/or data. The processing device 411 may be implemented as hardware (e.g., a microprocessor, etc.) or a combination of hardware and software (e.g., a system-on-chip (SoC), an application-specific integrated circuit (ASIC), etc.). The processing device 411 may be configured to perform one or multiple operations based on an operating system and/or various applications or programs.

The logic circuitry 410 may further include memory storage 412, which may include one or multiple memories and/or one or multiple other types of storage mediums. For example, the memory storage 412 may include a random access memory (RAM), a dynamic random access memory (DRAM), a cache, a read only memory (ROM), a programmable read only memory (PROM), flash memory, and/or some other type of memory. The memory storage 412 may include a hard disk (e.g., a magnetic disk, an optical disk, a magneto-optic disk, a solid state disk, etc.). The memory storage 412 is configured for holding computer program code, which may be executed by the processing device 411, wherein the logic circuitry 410 is configured to control the NTN TRP 141 to carry out any of the method steps as provided herein. Software defined by said computer program code may include an application or a program that provides a function and/or a process. The software may include device firmware, an operating system (OS), or a variety of applications that may execute in the logic circuitry 410.

Obviously, the NTN TRP 141 may include other features and elements than those shown in the drawing or described herein, such as a power supply, a casing, sensors, a satellite connector arrangement etc., but are left out for the sake of simplicity.

FIG. 5 schematically illustrates an example of a positioning node 160 for use in a wireless network 100 as presented herein, and for carrying out various method steps as outlined. The positioning node 160 may in various examples be operated as a Location Server, such as an Evolved Serving Mobile Location Centre (E-SMLC).

The positioning node 160 comprises a network interface 513 for communicating with various entities of the wireless network 100, such as the NTN TRP 141 and other access network components.

The positioning node 160 further comprises logic circuitry 510 configured to communicate data over the interface 513, and to make calculations based on data received through the interface 513 to establish a UE position estimation.

The logic circuitry 510 may include a processing device 511, including one or multiple processors, microprocessors, data processors, co-processors, and/or some other type of component that interprets and/or executes instructions and/or data. The processing device 511 may be implemented as hardware (e.g., a microprocessor, etc.) or a combination of hardware and software (e.g., a system-on-chip (SoC), an application-specific integrated circuit (ASIC), etc.). The processing device 511 may be configured to perform one or multiple operations based on an operating system and/or various applications or programs.

The logic circuitry 510 may further include memory storage 512, which may include one or multiple memories and/or one or multiple other types of storage mediums. For example, the memory storage 512 may include a random access memory (RAM), a dynamic random access memory (DRAM), a cache, a read only memory (ROM), a programmable read only memory (PROM), flash memory, and/or some other type of memory. The memory storage 512 may include a hard disk (e.g., a magnetic disk, an optical disk, a magneto-optic disk, a solid state disk, etc.). The memory storage 512 is configured for holding computer program code, which may be executed by the processing device 511, wherein the logic circuitry 510 is configured to control the positioning node 160 to carry out any of the method steps as provided herein. Software defined by said computer program code may include an application or a program that provides a function and/or a process. The software may include device firmware, an operating system (OS), or a variety of applications that may execute in the logic circuitry 510.

The positioning node 160 may further comprise, or be connected to, a position data storage 514, for storing data representing established UE position estimations. The position data storage 514 may take any shape as outlined for the memory storage 512.

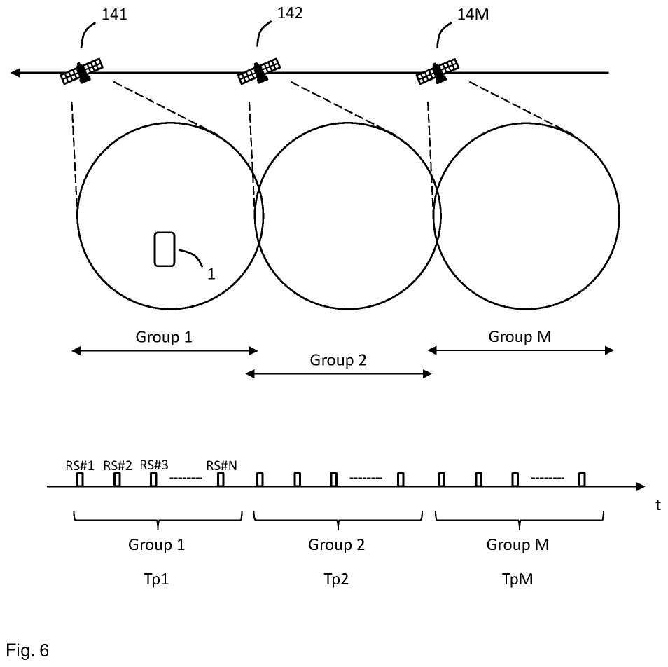

FIG. 6 schematically illustrates a scenario in which an example of the proposed solution is carried out. The overall objective, or basis, for the proposed solutions is to obtain a position estimation of the UE 1, based on reference signals transmitted from one or more NTN TRPs 141, 142, 14M. The reference signals, such as PRS, are received in the UE 1 and measured. In various examples, the actual calculation, such as trilateration or multilateration, based on measurements of two or more received reference signals may be carried out in the positioning node 160, responsive to receiving a measurement report from the UE 1. Alternatively, the UE 1 may be configured to make those calculations to establish an estimation of its own position. In the solutions presented herein, the UE 1 and the TRP 141 are nevertheless configured to facilitate the positioning of the UE 1.

In FIG. 6, a coverage area, corresponding to area 150 in FIG. 1, of each respective NTN TRP is illustrated by a circle by way of example. The coverage area represents an area projected on or close to ground. In some examples, an NTN TRP 141 may have only a single coverage area. Alternatively, the NTN TRP 141 may operate a plurality of beams at any given moment, wherein each beam has an associated coverage area. Each NTN TRP is moving in an orbit, i.e. the gravitationally curved trajectory of the satellite around Earth and may e.g. be arranged on a so-called Low Earth Orbit (LEO) or Medium Earth Orbit (MEO) type satellite. The respective NTN TRPs 141, 142, 14M are in some examples configured to have a common orbit, and in other examples the satellites may have different trajectories and/or may be orbiting at different altitudes. In the example of FIG. 6, the satellites are moving from right to left, as indicated by the arrow passing through them, with respect to the substantially stationary UE 1.

In various examples of the proposed solution, each NTN TRP is configured to transmit reference signals, such as PRSs, for reception in UEs in the coverage area of the respective NTN TRP. The reference signals are configured for measurement in the receiving UEs, during one positioning occasion, or positioning period, for determining a time stamp associated with reference signal reception. By measurement in a UE at two different reference signal occasions, i.e. two instances of reference signal transmission that occur within one positioning occasion, at different positions along the trajectory of the same NTN TRP, positioning of the UE may be carried out based on, inter alia, the relative time difference of reception of the reference signals, e.g. PRSs, and the known position of the NTN TRP at the respective reference signal occasion. Each measured received reference signal occasion may be associated with an angle of arrival (AoA) in the UE.

By positioning occasion, or positioning period, it is meant that the multiple reference signals received from one NTN TRP are used, in conjunction, during one instance of positioning the UE. This is in contrast to legacy systems in which, during a single positioning occasion, each NTN TRP will transmit only a single reference signal, with multiple NTN TRPs being required to send a reference signal in order to accurately determine a position of a UE.

In some examples, reference signal occasions are grouped within a certain duration of time Tp, that can be a function of satellite altitude of the NTN TRP. Higher satellite altitude may have longer duration Tp. In the example illustrated in FIG. 6, each coverage area on Earth, provided by an NTN TRP, is associated with a beam. The NTN TRP controls its beams, as it moves, to achieve a fixed association of a beam and an area on Earth. Each group may be associated per beam, and have an associated number of reference signal occasions within the duration Tp. As the NTN cells realized by the NTN TRPs are ground fixed, the duration Tp can be understood as a counter until the next NTN TRP takes over the NTN cell. Each reference signal occasion has an associated identifier, herein referred to as a reference signal occasion identifier RS #, such that two or more reference signals received and measured in the UE may be mapped to the occurrence of specific reference signal occasions. Each reference signal occasion identifier RS # thus relates to a time stamp of transmission from the NTN TRP, although it need not be expressed in a time unit. For example, the reference signal occasion identifier RS # may comprise an indication as to which number in a sequence of reference signal occasions, e.g. PRSs, the received reference signal is. This may be used by the UE or another device to determine where the NTN TRP was located and at what time the PRS was sent.

In some examples each group has an associated periodic reference signal pattern. In this periodic pattern, a sequence of a predetermined number of reference signal occasions are allocated. As shown in the example of FIG. 6, the NTN TRP 141 has a reference signal pattern comprising N reference signal occasions, or transmissions, having an associated reference signal occasion identifier RS #1 to RS #N within a group 1, within the duration Tp1 as the satellite carrying the NTN TRP 141 passes the area over the UE 1. Upon each reference signal occasion, the NTN satellite will have a different trajectory position.

According to one aspect of the proposed solution, a method is thus carried out in the UE 1 for facilitating positioning of the UE 1 in the communication network 100 which comprises an NTN access network of NTN TRPs 141-14M. The method comprises:
receiving at least two references signals, e.g. PRS, which are transmitted at different reference signal occasions from the same NTN TRP 141 at different satellite trajectory positions;
obtaining, for each received reference signal, a time stamp of reception and a reference signal occasion identifier conveyed in the reference signal, for calculation of a UE position.

Measuring the time of reception and/or other possible measurement (power, angle, phase) in the UE 1 of reference signals, and obtaining the related reference signal occasion identifier RS # for at least one of those signals, thus provides basic information for making a position estimation, since the reference signal occasion identifier RS # is associated with the time, which correlates to NTN TRP position, of transmission of the associated reference.

The lower part of the drawing shows the reference signal occasions at the position of the UE 1 as a function of time. While the UE 1 is within the coverage area of NTN TRP 141, reference signal occasions RS #1 to RS #N occur. The NTN TRP 141 passes and instead the NTN TRP 142 moves to cover the area of the UE 1. At reference signal occasion N+1, the point or area on Earth that received beam 1 of the NTN TRP 141 at transmission N will receive reference signal transmission 1 in the corresponding beam 1, but from the next satellite 142.

The UE 1 may thus subsequently receive reference signals from the NTN TRP 142, within a duration of Tp2, which may be the same length as Tp1 or different. The reference signal pattern of the NTN TRP 142, when covering the area of the UE 1, may in some examples be configured in the same way as the NTN TRP 141 did in Tp1. In this sense, the NTN TRPs may be synchronized to use the same reference signal occasions for a certain coverage area. Where the duration Tp2 is the same as Tp1, this means that Group 2 may comprise the corresponding N reference signal occasions, or transmissions, RS #1 to RS #N. In an alternative example, where the length of Tp2 is different from Tp1, Group 2 may comprise a different number of reference signal occasions than Group 1.

The UE is, in some examples, configured to identify, for each received reference signal, signal identity information conveyed in the reference signal, to determine a correspondence between the received reference signals. This correspondence may identify that the received and measured reference signals have the same NTN TRP as a source, meaning that they belong to a common Group. The signal identity information may comprise, or form part of, the reference signal occasion identifier, e.g. provided by a common bit pattern. Alternatively, the signal identity information may be conveyed as separate information. The signal identity information may comprise a TRP identity or, identify the source NTN TRP, or a cell ID, or the Group, and/or a resource identity, which may identify a beam in which the reference signal is transmitted. Each of the N reference signal transmissions may be associated with a Doppler shift. The reason for is that at the first reference signal transmission the satellite has a velocity toward the UE 1, at transmission N/2 the satellite is at zenith and has no velocity relative to the UE 1, and at transmission N it moves away from the UE. In some examples a Doppler compensation is associated with each PRS transmission and scaled with each n [1−N]. In an alternative example, there is no Doppler compensation applied, and instead the UE 1 assumes the Doppler scales with n.

In accordance with certain examples, at a snapshot given time T, M satellites carrying NTN TRPs (141, 142, . . . 14M), which move in a trajectory, cover M different regions or areas at the Earth. The duration that a UE 1 can be covered by an NTN TRP is within a certain period Tp, and within the period of Tp there can be a number reference signal resources, such as N reference signal resources for a reference signal resource-set within a group.

The UE 1 is configured to perform reference signal measurement with a minimum of two reference signal occasions within a group from the same NTN TRP. The total measurement time can be called a PRS measurement gap. During that PRS measurement gap, the UE may still receive PRS from other NTN TRP(s), e.g. from other trajectory/trajectories, which can be utilized to improve the positioning estimate. A positioning node, or alternatively the UE 1 itself, may trigger the UE 1 to make reference signal measurements based on reception of reference signals, such as PRSs. If the triggering of reference signal measurement causes measurement at the last N of reference signal occasions within a group, e.g. reference signal RS #N of Group 1, the UE 1 is in various examples configured to perform measurement in the next reference signal group, such as Group 2. In the scenario that some NTN TRPs do not transmit reference signals, the UE 1 is configured to wait for the next “active” group, e.g. Group 3. In accordance with some aspects, the UE 1 may be configured to measure a plurality X reference signals, where X is at least two and less than or equal to N. It may however be determined, in the UE 1, that not all those X reference signals may be obtained in a common period, such as Tp1, or Group 1, of a first NTN base station 141. In some examples, the UE 1 is thus configured to determine, based on the reference signal occasion identifier of one received reference signal, that said one received reference signal is a last reference signal RS #N transmitted in the period TP1 of reference signal transmission occasions. The UE 1 is in some examples thereby configured to determine time stamp of reception for at least two subsequent reference signals within the same subsequent period, e.g. Tp2. The UE 1 may thus be configured to discard any measurements carried out on previous reference signals in Tp1.

In some examples, NTN TRPs declare if reference signals in different Groups are coherent and measurements over groups is supported. This relates to if the satellites are synchronized to a level that supports accurate positioning, and potentially how accurate positioning the UE require or its processing capability. In such examples, where such indication of coherence satisfies such requirement and capability in the UE 1, reference signals received from different NTN TRPs may be measured to determine time stamp and reference signal occasion identifier, for positioning purposes.

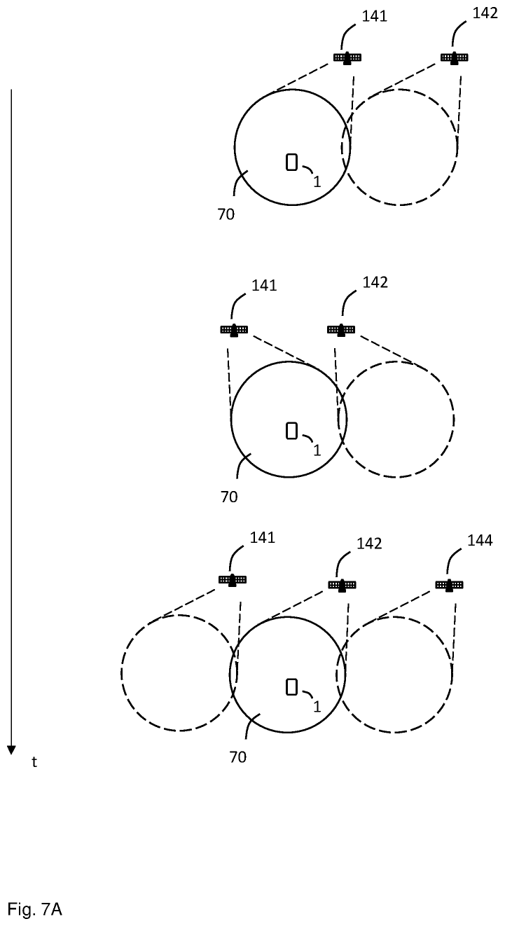

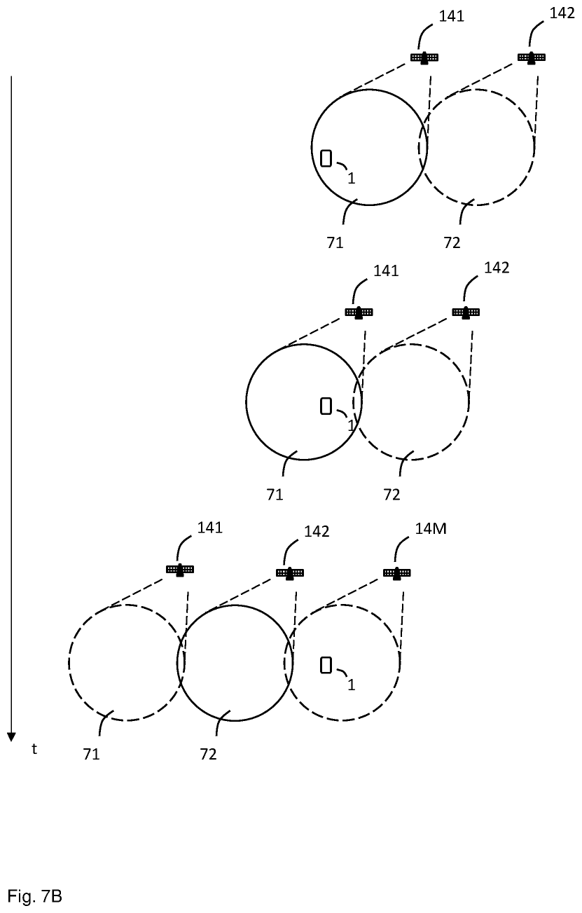

FIGS. 7A and 7B illustrate two scenarios of NTN access network configurations, in which the solutions proposed herein may be set out.

FIG. 7A illustrates an example of where NTN TRP beams have a fixed association with an area 70 on Earth. As an NTN TRP 141 moves along its trajectory, the area 70 is thus covered using a different AoA with respect to a point in that area 70, such as with respect to the UE 1, during Tp1. When the NTN TRP 141 moves away, that area 70 will subsequently instead be covered by a next NTN TRP 142, which will transmit reference signals during Tp2.

FIG. 7B illustrates another example, where NTN TRP beams have a fixed Angle of Departure from the NTN TRP, such that the coverage area 71, 72 of the NTN TRPs 141, 142 sweep over the surface of the Earth. As an NTN TRP 141 moves along its trajectory, the area 71 first covers a position where the UE 1 is located. The UE 1 may measure reference signals from the NTN base station 141 within a period Tp1, until the covered area 71 no longer covers the location of the UE 1. Subsequently, that location of the UE 1 will instead fall within the corresponding coverage area 72 of a next NTN TRP 142, which will transmit reference signals during Tp2.

The proposed solution involves the UE monitoring and receiving reference signals transmitted from one or more NTN TRPs. For this purpose, the UE 1 may be configured, by the wireless network 100, for such reference signal reception. This may involve receiving, from the network 100, configuration information of said reference signals, such as allocated resources.

In some examples, the capability to process reference signals, such as PRS, from a single NTN TRP or multiple NTN TRPs may form part of UE Radio Capabilities. The UE 1 may thus indicate, to the network 100, its capability to process reference signals when the UE 1 is initially connected to the network 100. A low-cost UE with limited processing power may only be able to process a single satellite (NTN TRP) at a time. This may e.g. be a low complexity IoT device, e.g. used for goods or vehicle tracking. In some examples the UE simply monitors the reference signals and saves measurement results, such as time stamp, reference signal occasion identifier and possibly RSTD measurement and/or RSRP measurement, phase measurement, beam ID, etc., to a local memory, e.g. memory 312. The stored data may be uploaded at a later time, so as not to waste energy on UL data transfer. A more powerful UE may be configured to process multiple NTN TRPs.

In various examples of the proposed general solution, the method may comprise transmitting a measurement report to a positioning node 160, such as a location server, in the communication network 100, based on the determined time stamps, and identifying at least one determined reference signal occasion identifier. In this context, the measurement report may comprise each time stamp of the received reference signals, and the associated determined reference signal occasion identifier. In a variant of this example, the determined time stamp of one received reference signal may be included as a time reference, and an indication of time difference between that one time stamp and the reception time of a further reference signal. The time stamp could be associated with the system frame number (SFN) and the position of PRS within an SFN. The time difference can be provided in the form of slot or symbol number relative to the reference point (time stamp). The UE 1 may thus be configured to transmit measurement results in a positioning measurement report, such as the timing measurement (e.g. RSTD measurement) and/or power measurement (e.g. RSRP measurement), phase measurement, beam ID, and identifying at least one time-stamp of reception. The time-stamp of reception can e.g. be associated with the time of the first reference signal occasion. Hence, the UE does not have to report all time-stamps to minimize the payload size. Specifically, if the UE 1 is assumed to measure consecutive reference signal occasions of a certain schedule, e.g. according to a predetermined periodicity, the UE 1 does not have to report the reference signal occasion identifier RS # (which identifies the time stamp of transmission at the respective reference signal occasion) for every measurement, as the reference signal occasion periodicity is known to the positioning node 160. In some examples, the UE 1 may thus include a single reference signal occasion identifier RS # (or at least fewer than all reference signal occasion identifiers RS #), and the associated time stamp of reception of that occasion. In addition, one or more time stamps of reception, or alternatively time differences to the reception, of further reference signal occasions, are included in the measurement report. This way, information identifying each received reference signal occasion is included, and can be used in the positioning node to obtain the required data for e.g. TDoA calculation. The indication of time difference can be in a unit of symbol duration or slot duration. If the indication of time difference may be an 8 bits report, a UE reports indication of time difference “00000010” means the PRS occasion is 2 symbols or 2 slots away from the reference time stamp.

According to some aspects, the proposed solution may include a method for facilitating positioning of the UE 1 in the communication network 100, carried out in an NTN TRP 141 of a non-terrestrial access network of the communication network 100. The method may comprise:
transmitting, at a plurality of reference signal occasions, references signals for reception in the UE;
wherein each reference signal conveys a reference signal occasion identifier, mapped to associated configured resources of that reference signal.

The method as carried out in the NTN TRP 141 may further comprise:
receiving, from the UE 1, a measurement report based on the time stamps determined upon reception in the UE 1 of the reference signals from the TRP;
transmitting the measurement report to the positioning node 160 in the communication network 100 for calculation of the UE position.

The TRP 141 may further be configured to provide configuration information of said reference signals, such as resource allocation, and trajectory information of the TRP 141, to the positioning node 160. This provides an association of satellite position of the NTN TRP and reference signal transmission timing. This information may be provided together with the measurement report, or separately, and even prior to the measurement report.

According to some aspects, the proposed solution includes a method carried out in the positioning node 160 for positioning of the UE 1 in the communication network 100. The method may comprise:
receiving, from the NTN TRP 141, configuration information for a plurality of reference signal occasions occurring at different satellite trajectory positions;
obtaining information of said satellite trajectory positions;
receiving a measurement report, originating from the UE 1, which measurement report identifies, for at least two of said reference signals:
   a time stamp determined upon reception in the UE, and
   a reference signal occasion identifier; and
calculating a position of the UE based on said measurement report. Calculation may e.g. be carried out in accordance with legacy procedures based on PRS measurement in a UE 1 and will not be described in detail herein.

In some examples of the proposed solution, the UE 1 may be configured to not only facilitate positioning by only performing positioning measurement, but also to calculate an estimation of its position. In such an example, the UE 1 is configured to obtain NTN TRP information identifying trajectory information and reference signal configuration, for at least the NTN TRP 141, 124, 14M from which the reference signals are received and measured. The UE 1 is further configured to calculate the UE position based on said time stamps and associated TRP positions determined by said NTN TRP information. Calculation may e.g. be carried out in accordance with legacy procedures based on PRS measurement in a UE 1 and will not be described in detail herein.

For the purpose of UE-based positioning, the UE 1 may thus require the information of satellite trajectory and its mapping to the reference signal transmission. However, sending complete satellite trajectory data to the UE 1 may not be necessary as it would require large data transmission and high occupancy of the UE 1 data storage capability. Furthermore, the UE 1 does not need the trajectory in e.g. an African region while the UE 1 is in North America.

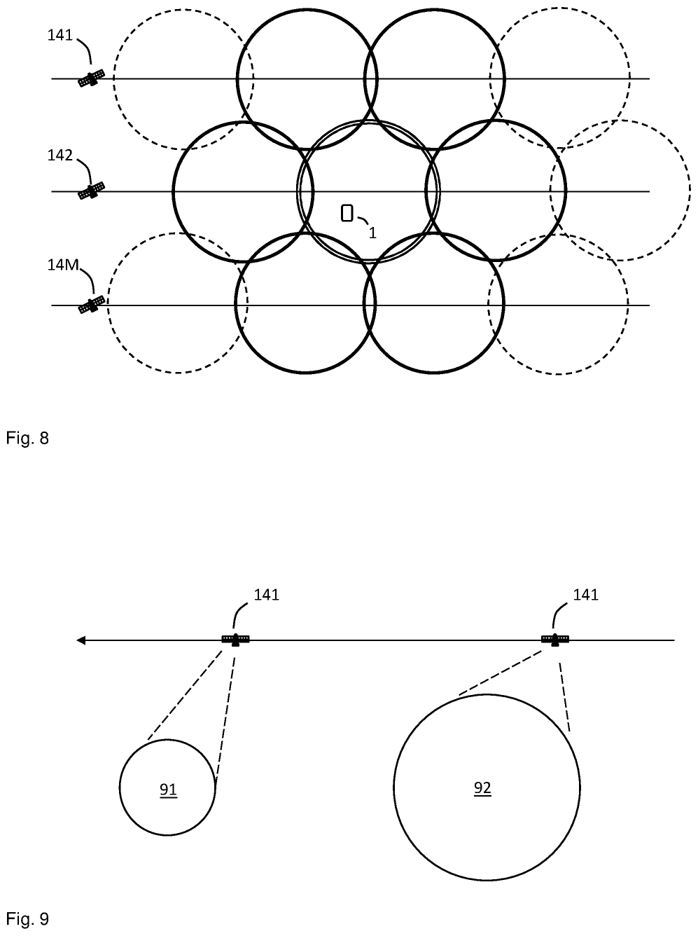

FIG. 8 schematically illustrates information obtainment of satellite trajectory or position information, according to some examples. This may be employed to support UE-based positioning, but also to obtain a measurement report in the positioning node 160 for UE positioning. The UE 1, currently within the coverage area of an NTN TRP 142, indicated by a double contour, detects signal identity information associated with that NTN TRP, to identify e.g. one or more of TRP ID, satellite ID, optionally beam ID. The UE 1 indicates the TRP ID, optionally with beam ID, at a given time to the positioning node 160. Based on the received information, the positioning node 160 provides trajectory information and reference signal properties, such as configuration, associated with that satellite ID and possibly of beams (marked with full contour) of further NTN TRPs 141, 14M which may be useful for facilitating positioning. The indication of NTN TRP ID by the UE 1 may be performed periodically so that the positioning node can regularly update the UE 1 with trajectory information and reference signal properties as needed. In an alternative example, the network broadcasts NTN system information, such as trajectory information and reference signal properties. This way, when the UE 1 enters a certain area, the appropriate information for that area may be obtained as system information.

The UE 1 may thus be configured to transmit signal source information, determined based on at least one of the received reference signals, to the access network, and to obtain NTN TRP information in response, from the positioning node 160 or from an NTN TRP. The NTN TRP information may identify trajectory information and reference signal configuration for at least the current NTN TRP, and possibly related to beams of further NTN TRPs.

FIG. 9 schematically illustrates an example of the proposed solution, wherein an NTN TRP coverage area, or beam, and its corresponding reference signal configuration, may depend on geographical region. In densely populated areas, such as cities, a smaller coverage area or beam 91 may be employed. On the other hand, in less populated areas, such as forest areas and at sea, a larger coverage area or beam 92 may be employed. The UE 1 may be arranged to determine a location of the UE in a predetermined region, such as either region 91 or 92. The location is here referred to as a wider area, such as a city, region, county, country etc. Reference signal configuration can in some examples therefore be dependent on beam configuration or foot-print area in NTN. The receiver in the UE may be configured to receive references signals based on the determined region, such as a beam configuration defined for that region. The location may be obtained based on stored data, such as a last detected NTN TRP ID, or based on a signal received from an NTN TRP. The UE 1 may thus configure its receiver 313 to receive said references signals based on the determined region. The configuration of reference signals may be dependent on the region, or a type/size of region, and the appropriate configuration may be obtained by the UE 1 based on the determined region, by mapping to configuration data in local memory. For example, in a determined region, the UE 1 can expect to receive reference signals from one or more NTN TRPs with the same or similar configuration, such as with the same reference signal period and/or the same reference signal structure, e.g. comb/symbol location within a slot.

Except where they are clearly contradictory, the solutions and examples disclosed herein may be combined in any form.

1. A method carried out in a user equipment (UE) for facilitating positioning of the UE in a communication network comprising a non-terrestrial access network of satellite-based access nodes, the method comprising:
receiving at least two references signals which are transmitted at different occasions from the same satellite-based access node at different satellite trajectory positions;
obtaining, for each received reference signal, a time stamp of reception and a reference signal occasion identifier conveyed in the reference signal, for calculation of a UE position.

2. The method of claim 1, comprising: identifying, for each received reference signal, signal identity information conveyed in the reference signal, to determine a correspondence between the received reference signals.

3. The method of claim 2, wherein said signal identity information comprises an access node identity.

4. The method of claim 2, wherein said signal identity information comprises a resource identity.

5. The method of claim 1, comprising: transmitting, to a positioning node in the communication network, a measurement report based on the determined time stamps for calculation of the UE position, identifying at least one determined reference signal occasion identifier.

6. The method of claim 1, comprising:
obtaining access node information identifying trajectory information and reference signal configuration, for at least said satellite-based access node;
calculating the UE position based on said time stamps and associated access node positions determined by said access node information.

7. The method of claim 1, comprising: obtaining further positioning information, for distinguishing between two separate locations determined based on the obtained time stamp of reception and reference signal occasion identifier.

8. The method of claim 1, comprising: transmitting signal source information, determined based on at least one of the received reference signals, to the access network; and obtaining, in response, access node information identifying trajectory information and reference signal configuration for at least said satellite-based access node.

9. The method of claim 1, comprising: determining a location of the UE in a predetermined region; configuring a receiver in the UE to receive said references signals based on the determined region.

10. The method of claim 1, comprising: determining, based on the reference signal occasion identifier, that one received reference signal is a last reference signal transmitted in a period of reference signal transmissions; determining time stamp of reception for at least two subsequent reference signals within the same subsequent period.

11. The method of claim 1, comprising determining configuration information of said reference signals.

12. The method of claim 11, wherein said configuration information identifies periodic transmission of reference signals.

13. The method of claim 11, wherein said configuration information identifies a predetermined number of reference signal occasions within a period of transmission of reference signals.

14. A method for facilitating positioning of a user equipment (UE) in a communication network, carried out in a satellite-based access node of a non-terrestrial access network of the communication network, the method comprising:
transmitting, at a plurality of reference signal occasions, references signals for reception in the UE;
wherein each reference signal conveys a reference signal occasion identifier, mapped to associated configured resources of that reference signal.

15. The method of claim 14, wherein each reference signal comprises signal identity information, identifying a correspondence between the reference signals.

16. The method of claim 15, wherein said signal identity information comprises an access node identity.

17. The method of claim 15, wherein said signal identity information comprises a resource identity.

18. The method of claim 14, comprising: receiving, from the UE, a measurement report based on the time stamps determined upon reception in the UE of the reference signals from the access node; transmitting the measurement report to a positioning node in the communication network for calculation of the UE position.

19. The method of claim 14, comprising: providing configuration information of said reference signals, and trajectory information of the access node, to the positioning node.

20-23. (canceled)

24. A method carried out in a positioning node for positioning of a user equipment (UE) in a communication network, comprising:
receiving, from a satellite-based access node of a non-terrestrial access network of the communication network, configuration information for a plurality of reference signal occasions occurring at different satellite trajectory positions;
obtaining information of said satellite trajectory positions;
receiving a measurement report, originating from the UE, which measurement report identifies, for at least two of said reference signals
a time stamp determined upon reception in the UE, and
a reference signal occasion identifier; and
calculating a position of the UE based on said measurement report.
